(19) United States
(12) Patent Application Publication
(10) Pub. No.: US 2006/0238497 A1
(43) Pub. Date: Oct. 26, 2006

(54) Peel-off auxiliary computing device

(75) Inventor: Suresh B. Velagapudi, Woodinville, CA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/207,998

(22) Filed: Aug. 22, 2005

Related U.S. Application Data
(60) Provisional application No. 60/673,777, filed on Apr. 22, 2005.

(51) Int. Cl. G09G 5/00

(52) U.S. Cl. 345/156

(57) ABSTRACT

An auxiliary computing device that can be electrically charged, synchronized, or updated when docked to a main computing device through a built-in data communications pathway. A computer system includes a first computing device with a microprocessor configured for operating computer-executable instructions. The first computing device may include a main body with a receiving portion. An auxiliary computer device may be removably coupled to the first computing device and received in the receiving portion. An auxiliary computing device serves a detachable display for a main computing system. The display provides for an enhanced user experience. The display while docked in the main computing system may be rotatably positionable for viewing by a user.

### CROSS REFERENCE TO RELATED APPLICATIONS

This application claims the benefit of U.S. Provisional Application No. 60/673,777 filed Apr. 22, 2005 in which the contents are incorporated by reference.

### FIELD OF THE INVENTION

The present invention relates to an auxiliary computing device. More particularly, the present invention relates to a removable auxiliary computing device for a computer system.

### BACKGROUND OF THE INVENTION

Conventional computer systems, especially computer systems using graphical user interface (GUI) systems, accept user input from a conventional input device, such as a keyboard for entering text, and a pointing device, such as a mouse for operating the graphical user interface. A traditional notion of user interaction is generally in front of a desktop computer or at least sitting within close viewing proximity to a display screen as with laptop computers. Conventional systems are problematic in meeting the challenge of user interaction for new media. The evolution of new media models of computing, such as digital television, digital music, digital movies, have changed the traditional view of the GUI, and the manner in which users can interact with their computers.

There are many usage problems in the new media environment. For example, users may attempt to separately ensure that each of their devices is charged for operation. Thus, this problem risks loss of valuable personal and corporate data if a power loss occurs. In another example, users may attempt to separately ensure the security of each device (both physical and password protected) as each carries valuable personal or corporate data. But, the users may forget their passwords. In another shortcoming, users attempt to separately address patches to keep up with improving software functionality. One significant problem is that the user must remember to keep all their devices synchronized. Users have to remember to carry all devices. In general, the different devices which carry data cause islands of data isolation. If one device is missing, then data for use of another device can not be used properly or data needed for operation may be missing. A user has to work through a plethora of connection choices and complex software configurations to be able to carry relevant data on all their devices.

What is needed is a computing apparatus and method to support user interaction for an untethered environment with an auxiliary computing device for manipulating the GUI for the new media technologies and productivity activities, such as creation and modification of electronic documents, spreadsheets, database, drawings, photos, electronic mail and the like.

### SUMMARY

The present invention pertains to an auxiliary computing device that can be electrically charged, synchronized, or updated when docked to a main computing device through a built-in data communications pathway.

In one aspect, a computer system includes a first computing device with a microprocessor configured for operating computer-executable instructions. The first computing device may include a main body with a receiving portion. An auxiliary computer device may be removably coupled to the first computing device and received in the receiving portion.

In another aspect, the auxiliary computer device may be nested within the receiving portion of the first computing device. When the first computing device and auxiliary computing device are coupled together, the first computing device is configured to electrically charge a mobile power source in the auxiliary computing device or indicate wireless network access.

In another aspect, synchronization functionality is provided when an auxiliary computing device is docked into a base computing unit. The auxiliary computing device may be the undocked from the base computing unit. The auxiliary computing device may include user input functionality and may be of a reduced size for off-desk implementation.

In another aspect, an auxiliary computing device serves a detachable display for a main computing system. The display provides for an enhanced user experience. The display while docked in the main computing system may be rotatably positionable for viewing by a user.

Thus, aspects and features of the present invention enable users to enjoy experiences of rich digital media, such as gaming with a computer system or navigate the Internet, send and receive electronic mail messages or Instant Messaging, operate spreadsheets, create documents and presentations with ease of operation in a new media environment.

The above and other aspects, features and advantages of the present invention will be readily apparent and fully understood from the following detailed description illustrative embodiments in conjunction with the accompanying drawings, which are included by way of example, and not by way of limitation with regard to the claimed invention.

### BRIEF DESCRIPTION OF THE DRAWINGS

FIG. 1 is a functional block diagram of an illustrative general-purpose digital computing environment in which one or more aspects of the present invention may be implemented;

FIG. 2 is a schematic representation of an auxiliary computing system arrangement according to one or more aspects of the present invention;

FIG. 3 is a schematic representation of a computing system arrangement according to one or more aspects of the present invention;

FIG. 4 is a schematic representation of an auxiliary computing system in an undocked arrangement according to one or more aspects of the present invention;

FIG. 5 is a functional block diagram of a computing system arrangement shown in FIG. 2 according to one or more aspects of the present invention;

FIG. 6 is a functional block diagram of a computing system arrangement shown in FIG. 3 according to one or more aspects of the present invention;

FIG. 7 is a schematic diagram of the computing system arrangement and auxiliary computing system shown in FIG. 3 according to one or more aspects of the present invention;

FIG. 8 is a schematic diagram of the computing system arrangement and auxiliary computing system shown in FIG. 3 according to one or more aspects of the present invention;

FIG. 9 is a schematic diagram of the computing system arrangement and auxiliary computing system shown in FIG. 3 according to one or more aspects of the present invention;

FIG. 10 is a representation of an auxiliary computing system arrangement according to one or more aspects of the present invention;

FIG. 11 is a representation of an auxiliary computing system arrangement shown in FIG. 10 according to one or more aspects of the present invention; and

FIG. 12 is schematic diagram of a graphic display and information content according to one or more aspects of the present invention.

### DETAILED DESCRIPTION

Illustrative Operating Environment

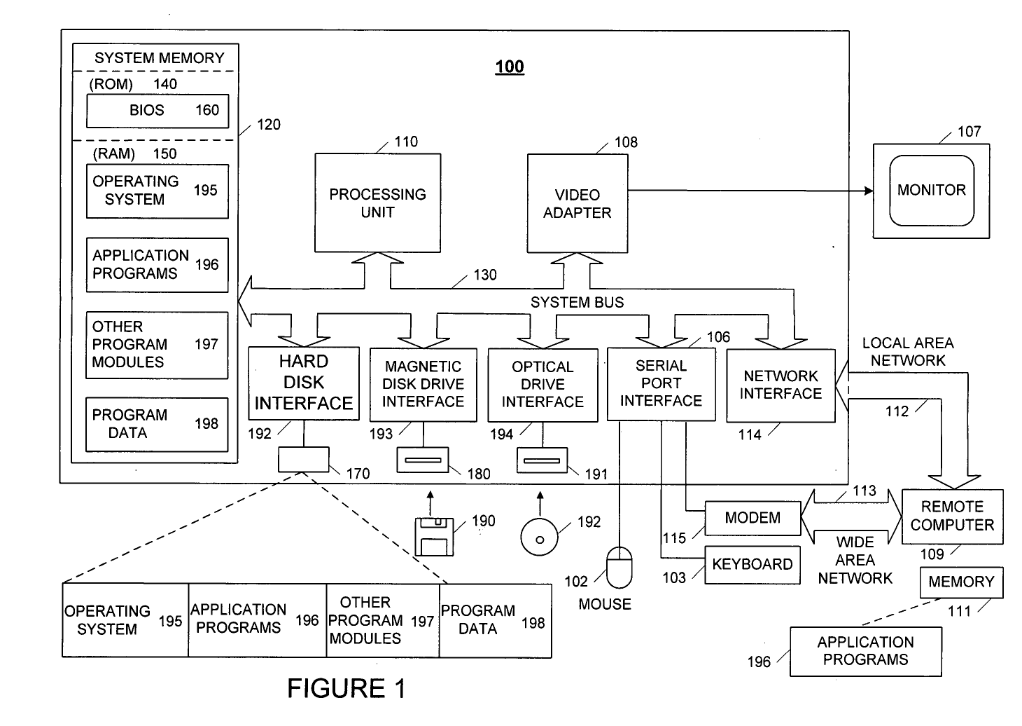

Various aspects of the present invention may at least be described in the general context of apparatus and computer-executable instructions, such as program modules, executed by one or more computers or other devices. Accordingly, it may be helpful to briefly discuss the components and operation of a general purpose computing environment on which various aspects of the present invention may be implemented. A host computer system can be used for processing data new media technology environment. Such an illustrative host computer system 100 is illustrated in FIG. 1.

Accordingly, FIG. 1 illustrates a schematic diagram of an illustrative general-purpose digital computing environment that may be used to implement various aspects of the present invention. In FIG. 1, the host computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules, and other data for the personal computer 100. It will be appreciated by those skilled in the art that other types of computer readable media that may store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules may be stored on the hard disk drive 170, magnetic disk 190, optical disk 192, ROM 140, or RAM 150, including an operating system 195, one or more application programs 196, other program modules 197, and program data 198. A user may enter commands and information into the computer 100 through input devices, such as a keyboard 103 and a pointing device 102. Other input devices (not shown) may include a microphone, joystick, game pad, satellite dish, scanner, or the like. These and other input devices often are connected to the processing unit 110 through a serial port interface 106 that is coupled to the system bus 130, but may be connected by other interfaces, such as a parallel port, game port, or a universal serial bus (USB). Further still, these devices may be coupled directly to the system bus 130 via an appropriate interface (not shown). A monitor 107 or other type of display device with a display screen is also connected to the system bus 130 via an interface, such as a video adapter 108.

The computer 100 may operate in a networked environment using logical connections to one or more remote computers, such as a remote computer 109. The remote computer 109 may be a server, a router, a network PC, a peer device, or other common network node, and may include many or all of the elements described above relative to the computer 100, although only a memory storage device 111 with related applications programs 196 have been illustrated in FIG. 1. The logical connections depicted in FIG. 1 include a local area network (LAN) 112 and a wide area network (WAN) 113. Such networking environments are commonplace in offices, enterprise-wide computer networks, intranets, and the Internet.

When used in a LAN networking environment, the computer 100 is connected to the local network 112 through a network interface or adapter 114. When used in a WAN networking environment, the personal computer 100 typically includes a modem 115 or other means for establishing a communications link over the wide area network 113, e.g., to the Internet. The modem 115, which may be internal or external, is connected to the system bus 130 via the serial port interface 106. In a networked environment, program modules depicted relative to the personal computer 100, or portions thereof, may be stored in a remote memory storage device.

It will be appreciated that the network connections shown are exemplary and other techniques for establishing a communications link between the computers may be used. The existence of any of various well-known protocols such as TCP/IP, Ethernet, FTP, HTTP and the like is presumed, and the system may be operated in a client-server configuration to permit a user to retrieve web pages from a web-based server. Any of various conventional web browsers may be used to display and manipulate data on web pages.

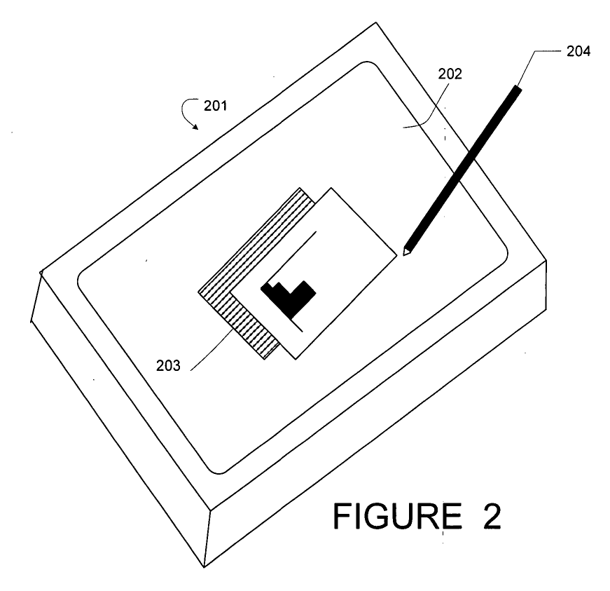

FIG. 2 illustrates an auxiliary computing system 201 that may be used in accordance with various aspects of the present invention. Any or all of the features, subsystems, and functions in the system environment 100 of FIG. 1 may be included in the computer system 201 of FIG. 2. Thus, auxiliary computing system 201 may include a local processing unit, a system memory, and a system bus that couples various system components including the system memory to the processing unit. Nevertheless, auxiliary computing system 201 may include various other components, such as a local speaker for audio playback and a microphone for receiving audio signals.

Auxiliary computing system 201 may have a body or housing 238 that may be configured to fit within a user's hand or hands. Body 238 may be formed with conventional manufacturing methods and can be formed of a desired shape with suitable plastic material. Further, auxiliary computing system 201 includes a display surface 202, e.g., a digitizing flat panel display, such as a liquid crystal display (LCD) screen, on which a plurality of graphical objects are displayed. The display surface 202 may be used with a number of writing devices. For example, using stylus 204, a user may select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. In one example, auxiliary computing system 201 may interpret gestures made using stylus 204 in order to manipulate data, enter text, create drawings, and/or execute computer application tasks, such as spreadsheets, word processing programs, and the like.

The stylus 204 may be equipped with one or more buttons or other features to augment its selection capabilities. In one example, the stylus 204 may be implemented as a “pencil” or “pen,” in which one end constitutes a writing element and the other end constitutes an “eraser” end, and which, when moved across the display, indicates portions of the display to be erased. Other types of input devices, such as a mouse, trackball, or the like may be used. Additionally, a user's own finger may be the stylus 204 and used for selecting or indicating portions of the displayed image on a touch-sensitive or proximity-sensitive display. Consequently, the term “user input device,” as used herein, is intended to have a broad definition and encompasses many variations on well-known input devices, such as the stylus 204.

Nevertheless, auxiliary computing system 201 may be a display surface 202 which may provide displaying of graphical objects without the surface being touch-sensitive or writable for digital characters. A few terms are defined for ease of explanation. An object is located on the “front” of computing system 201, when it is in a viewing direction for the display surface 202. An object is located on a “back” of computing system 201 when it is in a direction opposite of the display surface 202, e.g., opposite of the viewing direction. An object is located on the “side” of system 201 when it is located relative to the edge of display surface 202 between the front and back directions.

Auxiliary computer system 201 may include on/off and navigation buttons for navigating a graphical user interface and the like. These attributes can vary based on target factors like battery life, device size, and weight. Auxiliary computing system 201 may operate a device operating system such as PocketPC. Nevertheless, other operating systems may be employed. For data input, auxiliary computer system 201 may include card readers for Secure Digital, Compact Flash, and other data formats and format factors. In another aspect, the system 201 may have mobile phone functionality built-in for use when docked or undocked from a host computer.

In various embodiments, the system 201 can provide an ink platform as a set of COM (component object model) services that an application can use to capture, manipulate, and store ink. One service enables an application to read and write ink using the disclosed representations of ink. The ink platform may also include a mark-up language including a language like the extensible markup language (XML). Further, the system may use DCOM as another implementation. Yet further implementations may be used including the Win32 programming model and the .Net programming model from Microsoft Corporation.

Illustrative Computing Arrangements

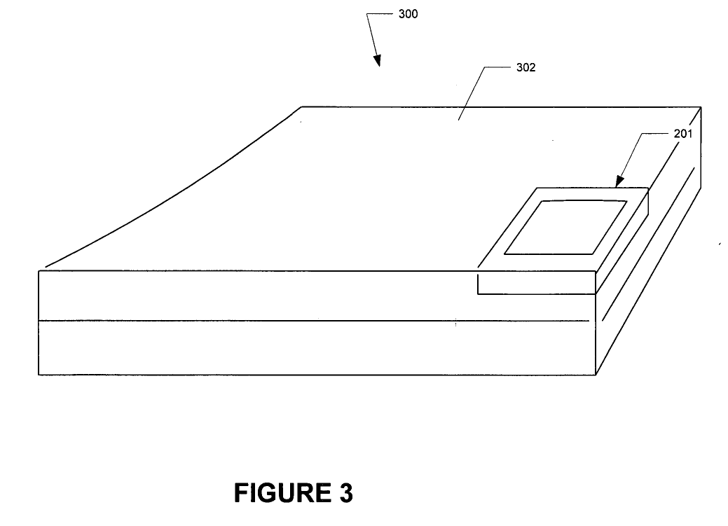

FIG. 3 is one arrangement of a computer system 300 which includes a base unit 302, such as host computer 100 and an undockable or peel-off portion, such as auxiliary computer system 201. Computer system 201 may be implemented in accordance with various aspects that allow user interaction for manipulating a local graphical user interface for new media technologies and productivity activities, such as creation and modification of electronic documents, spreadsheets, database fields, graphic objects, drawings, photos, calendar, tasks and the like. In one configuration, base unit 302 may be generally embodied in a notebook or laptop configuration. Auxiliary computing system 201 may be embedded within the lid of a laptop, or alternatively next to the touchpad by a keyboard. While FIG. 3 generally shows a clamshell type of computer, such as a notebook computer, it is understood that other configurations may be used without departing from the scope of the invention. For example, a desktop or TabletPC may be used to implemented various features.

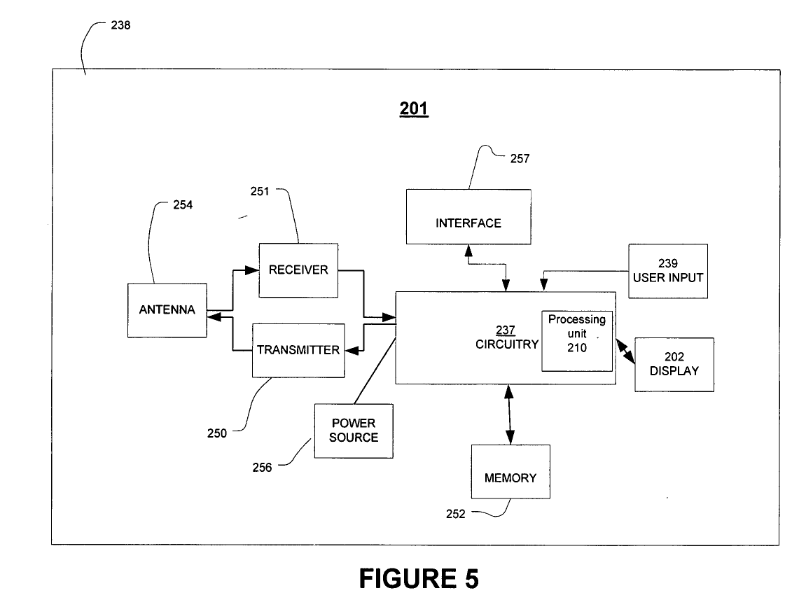

FIG. 5 is a functional block diagram of an auxiliary computing system 201 according to one or more aspects of the present invention. Auxiliary computing system 201 includes circuitry 237 configured with hardware and software, such as a processing unit 210 and computer readable instructions. Processing unit 210 includes one or more microprocessors as known in the art for operating on electrical input, such as digital data. Circuitry 237, including processing unit 210, is operatively connected to a radio frequency transmitter 250, and radio receiver 251, computer readable memory 252, display 202, and user input 239. User input 239 may include navigation and selections buttons for operating a graphical user interface, namely up, down, left, right, back, enter and menu. User input 239 may also include a microphone operatively connected to circuitry 237 via logical connections and physical wiring. The memory 252 can serve as a local cache may be a programmable type in which nonvolatile storage can be electrically erased and reprogrammed. Possible alternatives include flash memory, flash ROM, RAM and the like. Nevertheless, the memory 252 may embodied as system memory. Auxiliary computing system 210 includes a mobile power source 256 for providing electrical power via one or more batteries and the like. Receiver 251 is operatively coupled to antenna 254 to processing unit 210 for receiving wireless messages/signals. Transmitter 250 is also operatively coupled to processing unit 210 for transmitting signals via an antenna 254. The signals are received by the base unit 302, or other electronic equipment, which is enabled to receive and process wireless signals. For example, the wireless signals may be received and processed by an appropriately configured wireless hub for a corporate data infrastructure access and the like.

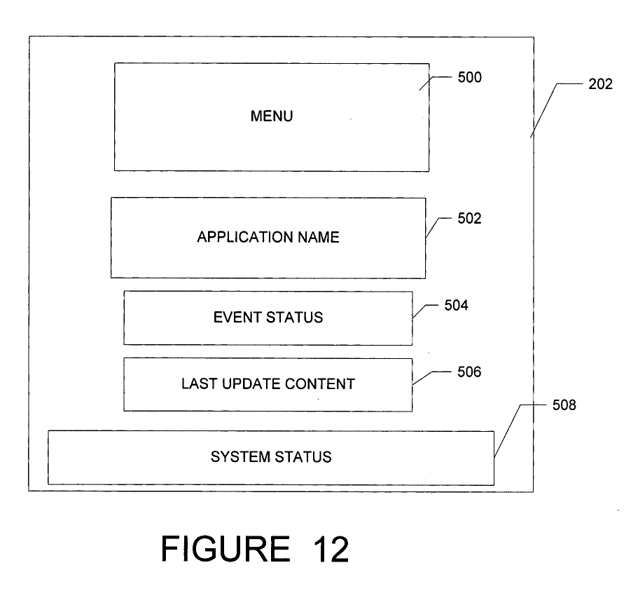

Various system operating configurations are provided when the auxiliary computing system 201 is docked and when the base unit 302 is in a standby mode or a hibernating mode. In one example, auxiliary computing system 201 can be independently turned on or off. In this arrangement, power on and off can be nearly instantaneous because of the smaller overhead operating system running on the system. In another arrangement, auxiliary computing system 201 is enabled to allow digital media playback, such as video and audio files from local memory/computer readable storage 252 (See FIG. 5). System 201 can also display via display surface 202 when and where the next meeting is located via a locally operating contacts or calendaring application software. In another configuration, auxiliary computing system 201 can assist the user to read local electronic mail, based on software plug-ins available on the device. In another configuration when the base unit 302 is turned off, the auxiliary computing system 201 enables a user to navigate through the rich set of data that is cached on the local storage, such as memory 252. To extend the battery life of the base unit 302 (embodied as a laptop/notebook arrangement) and to get the latest information, the auxiliary computing system 201 can be configured to “wake up” the base unit 302 periodically and retrieve latest electronic mail from a mail server and then put the unit 302 back to a standby mode or hibernate mode. In another configuration, auxiliary computing system 201 is enabled to monitor availability of wireless WiFi hotspots or locations for wireless network access and indicate the same to the user without having to power up the base unit 302. This indication of wireless hotspot can be provided on a relevant portion of display surface 202, such as a graphical icon or other graphical objects. For example, in FIG. 12, the indication of the hotspots could be on the system status bar 508.

Referring to FIG. 3, various system operating configurations are provided when the auxiliary computing system 201 is docked in the base unit 302 and the base unit 302 power is turned on or in an operating state for use. In one arrangement, the auxiliary computing system 201 is enabled for automatic synchronization of digital content specified through a central configuration program in base unit 302. In one case, the automatic synchronization may occur at specified intervals. For example, the automatic synchronization may be based on elapsed time intervals between downloads from base unit 302 and the like. In one of many examples, the digital information synchronized can be productivity data, such as calendar information, tasks, contacts, and electronic mail, as well as personal data or business data such as music, pictures, or video files. In this way, the user is provided with ease of use and ease of operation of computing system 201. That is, by docking the auxiliary computing system 201, the base unit 302 becomes aware of the computer system 201 and synchronization occurs for data update. This awareness feature can be provided by appropriate computer readable instructions or via a plug-and-play arrangement with operating system 195 (See FIG. 1)

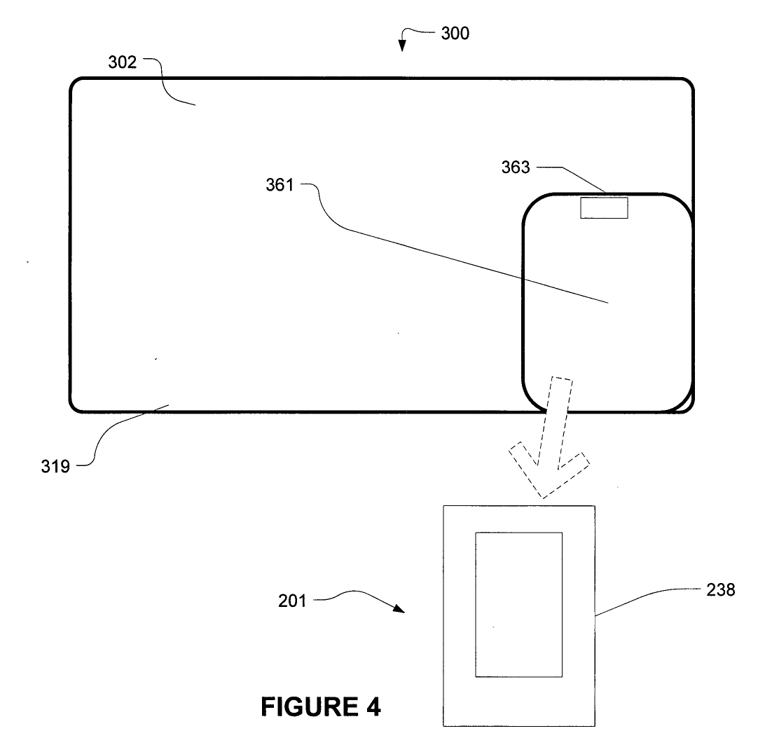

FIG. 4 is a schematic representation with the auxiliary computing system 201 undocked or removed from the base unit 302 for use. In this undocked or removed configuration, auxiliary computing system 201 may operate in a number of functional arrangements. For example, auxiliary computing system 201 may serve as a full function personal digital assistant. By using local storage, the computing system 201 can display the most up-to-date set of personal contacts, calendar information and electronic mail up to the last synchronization time, e.g., when last docked. In another arrangement, the auxiliary computing system 201 may serve as media player or a portable media device for presentations of digital videos and/or digital audio files. In yet another arrangement, the auxiliary computing system 201 may be used by a user to navigate digital photos or the system 201 serve as an interactive digital photo-frame display for digital photos. As more explained herein, computer system 201 may transmit data to the host computer 100 via a wireless connection when undocked. The wireless connection arrangement provides the user with untethered freedom to use the computer system 201 in a new media computing environment. The auxiliary computing system 201 can wirelessly communicate with the base unit 302, if it is within range through Bluetooth™ or IEEE 802.11 when the base unit 302 is powered. Alternatively, if 802.11 wireless infrastructure is available at an operating location, the auxiliary computing system 201 may connect to corporate data sources, such as electronic mail servers to synchronize electronic mail, calendar, and tasks. In yet another alternative, auxiliary computing system 201 can also provide web-browsing. In yet another alternative configuration, the auxiliary computing system 201 may by serve as a travel clock including alarm functionality.

In order to prevent data theft and other problems, undocking the peel-off unit 201 can render the data on the base unit 302 unreadable as a standalone unit. In accordance with one aspect, this can be accomplished using data encryption methods. An encryption process is provided for converting data into a format that cannot be read by another user using a unique private key. A decryption process is provided for converting data from encrypted format back to its original format. Hence, the private key used for encryption enables the decryption process. In this configuration, digital keys for decrypting the data contents of the base unit 302 (host computer 100) can be stored on the local computer readable storage 252 of the peel-off unit 201. Thus, when the auxiliary computing system 201 is re-docked into the base unit 302, the digital keys are read and the data becomes decrypted for use. This configuration is advantageous for the user to lockdown the computer 300 while it is powered up. This is helpful when the user is away of the base unit 302 and unauthorized access is prevented.

In another configuration, the user can result in decryption of the data contents of the base unit 302 (host computer 100) by merely being in the proximity with the auxiliary computing system 201 (without having to re-dock). When the host computer establishes a wireless connection with auxiliary computing system 201 that is in the user's possession, it can extract the required private key required to decrypt the encrypted data.

In one case to ensure personal identity for the auxiliary computing system 201, a biometric device, such as a finger print reader, may be disposed on the auxiliary computing system 201 housing body 238. Suitable fingerprint readers are available in a small form factor. The device may scan a finger tip of a user's hand so as to store a digital fingerprint. For example, a thumbprint may be scanned by a fingerprint reader. The digital fingerprint is stored in memory. Auxiliary computing system 201 may be configured to compare the received digital fingerprint with a predetermined fingerprint stored in a computer readable memory 252 for a particular user. If there is a fingerprint match between the received fingerprint and the predetermined fingerprint, then a signal is sent to transfer the digital keys wirelessly to base unit 302. Alternatively, the when the auxiliary computing system 201 is re-docked into base unit 302, the digital keys can be transferred in the wired configuration. In another feature, the correct biometric identity can enable the auxiliary computing system 201 operational for the particular user. These configurations provides a two-level security feature to prevent unauthorized users to take the auxiliary device with the digital keys and attempt to use base unit 302. Thus, the auxiliary computing system 201 provides high level of security for the base unit 302 and the device 201 itself.

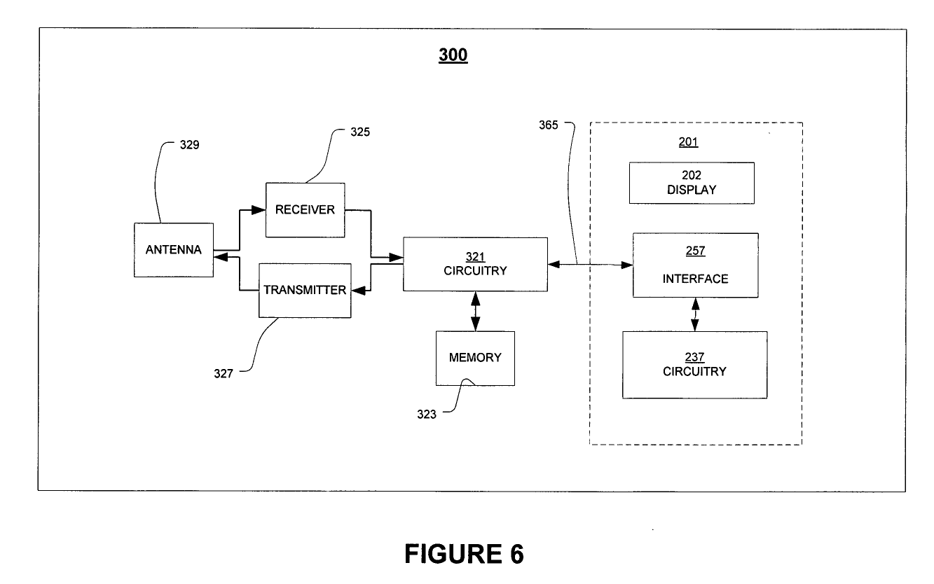

FIG. 6 is a functional block diagram of computing system 300 having auxiliary computing system 201 docked therein according to one or more aspects of the present invention. In one arrangement, computer system 201 may be configured to draw electrical power from host computer 100 when physically coupled or nested therein. In yet another arrangement, computer system 201 includes body 238 is adapted to be physically coupled and uncoupled or nestable to provide removability with base unit 302 (host computer 100). These features are discussed in detail herein.

For ease of explanation, FIG. 6 shows in dotted lines, wireless auxiliary computing system 201. Any or all of the features, subsystems, and functions in the system environment 100 of FIG. 1 may be included in the computer system 300 of FIG. 2. For example, referring to FIG. 6, computer system 300 may include a control circuitry 321, such as processing unit 110 with computer readable instructions, data structures, program modules, and other data shown in FIG. 1. Control circuitry 321 is operatively connected to receiver 325, transmitter 327, and computer readable memory 323. The memory 323 may be embodied as the system memory 103 shown in FIG. 1. Memory 323 may be any programmable type in which nonvolatile storage can be electrically erased and reprogrammed. Possible alternatives include flash memory, flash ROM, RAM and the like. In FIG. 6, receiver 325, transmitter 327 and antenna 329 provide a function of allowing the base unit 302 to connect wirelessly to the auxiliary computing system 201 or other device, such as a wireless hub. It should be recognized that the terms transmitter, receiver and antenna are used for ease of explanation in that they may embodied in many different alternatives forms. For example, a transmitter and a receiver can be embodied as a transceiver or a bi-direction communication data port, such as with infrared communications. An antenna can be embodied for receiving or sending radio frequencies.

It should be recognized that computer system base 302 and computer system 201 may include a receiver and a transmitter (or a transceiver) operatively coupled to the processing unit 110, 210 via the system bus or serial connection. The wireless connection may include infrared frequencies or radio-controlled frequencies, such as Bluetooth radio-frequency (“RF”) specification and protocols. One type of wireless connection may be the widely available communication standards such as, the Infrared Data Association (“IrDA”) specification and protocols, such as IrDA Data or IrDA Control. The IrDA communication protocols provides low-cost, short-range, cross-platform, point-to-point communications at various transfer rates for devices employing the standardize protocol. There are various suppliers of IrDA compatible hardware for transceivers and interfacing software modules. Nevertheless, the wireless connection may radio frequency based. The radio-controlled configuration may include a transmitter and receiver operating at 27 MHz, but other alternative frequencies may be implemented. Further, it is contemplated that base unit 302 and computer system 201 may have Wi-Fi capability such that it can communicate via a wireless network using 802.11 protocol. Nevertheless, any appropriate wireless transmission protocol or wireless medium arrangement can be employed to wirelessly connect auxiliary computing system 201 to access networks or local area networks.

In a docked configuration with base unit 302, auxiliary computing system 201 may serve as a display for the auxiliary display functionality. In one of several advantages, the battery life is extended in a notebook configuration of computer system 300. Also, the audio level of a computer 300 (host computer 100) can be minimized to lengthen battery life. In one configuration, system 201 is embodied as a small secondary display device that is easily visible and available when the main display (monitor 107) is off. The display may be a color or grey-scale bitmap screen that conforms to several resolutions. Base unit 302 may include an event-driven auxiliary manager service provided by the operating system as an application program interface (API), for example. In one arrangement, the manager service generally acts as a software interface between the hardware (computing system 201) and the plug-ins. An auxiliary display plug-ins is provided as a mini-application that puts information on the aux display, e.g., computing system 201, via the auxiliary manager service. In auxiliary computing system 201 may receive different types of notifications from the base unit 302 for presentation of screen 202. The protocol can remain the same whether the connection between the PC and the peel-off device is hard-wired (docked) or wireless (undocked).

To facilitate the user experience with the auxiliary computing system 201, an application module runs on the processing unit 210 which provides for a top-level menu where a user can select a desired program. The application module also provides for a graphical bar at the bottom of the screen 202 to show system status, for example. For security purposes, the application module may lock and unlock the auxiliary computing system 201 by receiving a user password, Personal Identification Number (PIN) and the like. A cache module may be provided to control the store plug-in data to upload data for display. Rendering module may be provided to receive data from the Cache module. The rendering module parse data coming from the base unit 302 or stored in the cache (memory 252) and display the data of the display surface 202. The application module, cache module and rendering module are provided on auxiliary computing system 201.

FIG. 12 is a schematic representation of a graphical display screen with various display portions for presentations of data, content and other information. The display screen 202 has graphical user interface that includes a first display portion 500 having a graphical top-level menu 500. A second display portion 502 is provided which is indicative of an application program running for provide quick content to the user, such as electronic mail system and media playback program. A third display portion 504 provides an event status related to the application program. For example, an in electronic mail implementation, the number of unread messages in the user's inbox may be displayed. In a media application, the number of songs or the artist and the number of songs may be displayed. Nevertheless, other information for display is possible. A fourth display portion 506 provides or displays information pertaining to the last update synchronization and related information. For example, the date and time of the most recent update may be displayed. A fifth display portion 508 provides a graphical status bar. This status bar can have a multiplicity of information including battery capacity meter, wireless signal strength, the current time and date. Nevertheless, other types of the information are possible. Display portions 500-508 are shown in screen 202 by way of the example and the order of the locations on the screen can be varied for a specific implementation.

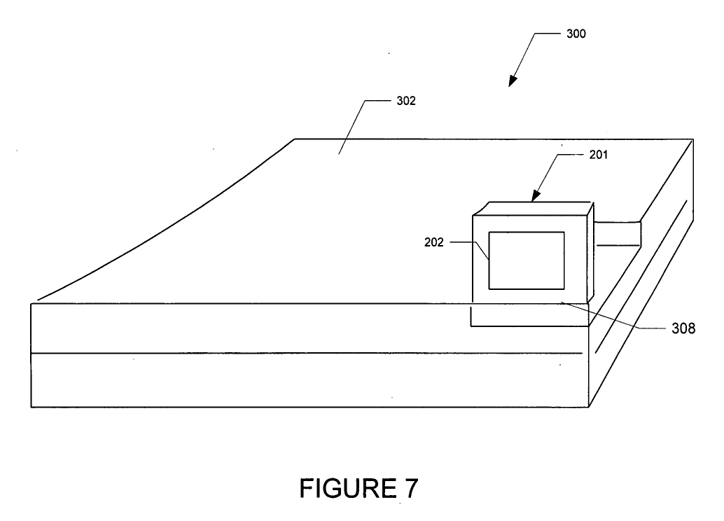

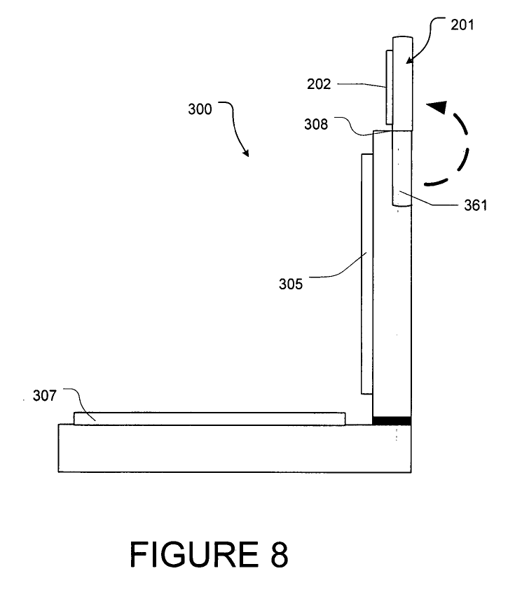

In one configuration, shown in FIGS. 7 and 8, the auxiliary computing system 201 serves as an auxiliary display or detachable display, which can be swiveled towards the main screen. In this configuration auxiliary computing system 201 serves as a second display or can provide additional graphics for presentations. For example, as shown in FIG. 8, computer system 300 (in a notebook configuration) may include a display surface 305 and a keyboard 307. In this arrangement, computer 300 includes two housing members or case members for the retaining components, e.g., one housing member for the display screen 305 and the other housing member for the keyboard 307. In a position shown in FIG. 7, computer 300 has the housing members in a “closed position”. In this closed position, auxiliary computing system 201 can be enabled to rotate into a viewing position by the user. Thus, system 201 with base unit 302 may have a hinge 308 which allows variable angular positioning with respect to the horizontal or the case member. For example, the auxiliary computing system 201 may be rotated between 0-180 degrees or more. In FIG. 7, auxiliary computing system 201 is rotated about 90 degrees from a plane which may be defined by the back of the vertical case member. As shown in FIG. 8, the system 201 is rotated about 180 degrees from a plane which defines of the back of the case member. It should be recognized that computer 300 when used in a notebook mode or a laptop mode for keyboard input and auxiliary computer system serves an auxiliary display device.

With reference to FIG. 6, in one arrangement of computer system 300, auxiliary computing system 201 may be removably coupled (docked) via a signal interface connection 365 to provide electrical coupling and physical connection. In one such interface arrangement, base unit 302 may be electrically coupled to auxiliary computing system 201 by way of a bus type arrangement for bi-directional signaling and communications. One type of bus arrangement is a System Management Bus (SMBus) arrangement. Alternatively, in another signal interface arrangement, auxiliary computing system 201 may be electrically coupled to base unit 302 by way of a bi-directional serial type connection. In these arrangements to provide mateable electrical connections, conventional male and female electrical connectors can be used for physical metal-to-metal contact to transmit electrical data signals. It should be recognized that any conventionally appropriate electrical connectors for electrical signaling configuration may be used for the previously discussed connections.

In one coupling arrangement, referring to FIGS. 5 and 6, auxiliary computing system 201 may include a synchronization interface 257 which is configured cooperate with signal interface connection 365 of circuitry 321 of base unit 302. For ease of explanation, FIG. 6 shows in dotted lines, wireless auxiliary computing system 201 with control circuitry 237 and the synchronization interface 257. Synchronization interface 257 in conjunction with circuitry may be embodied in the numbers of formats to provide electrical and logical coupling. In one example, synchronization interface 257 may be a component of a Universal Serial Bus (USB) connection. The USB standard has wide spread use for connecting peripherals to computers. In this example, the control circuitry 321 may include the software to operate with the USB standard, such as a USN client. In one embodiment, this Universal Serial Bus can be the Universal Serial Bus-On-the-GO (USB-OTG) standard configured for portable device-to-device communications without a general purpose computer. This implementation is useful in that USB-OTG has low power consumption of about 8 milliamps to preserve the battery operating life. In an USB-OTG implementation, using a topology of host/peripheral, the control circuitry 321 of base unit 302 acts as a host device and auxiliary computing system 201 becomes a peripheral device to the host computer 100. Further, data transfer with the USB-OTG allows symmetric bi-directional communications between connected devices. In accordance with an embodiment, auxiliary computing system 201 can send input data or digital content to base unit 302 for processing. Likewise, base unit 302 may send control data and/or other data to auxiliary computing system 201 for data control purposes and viewing on display 202.

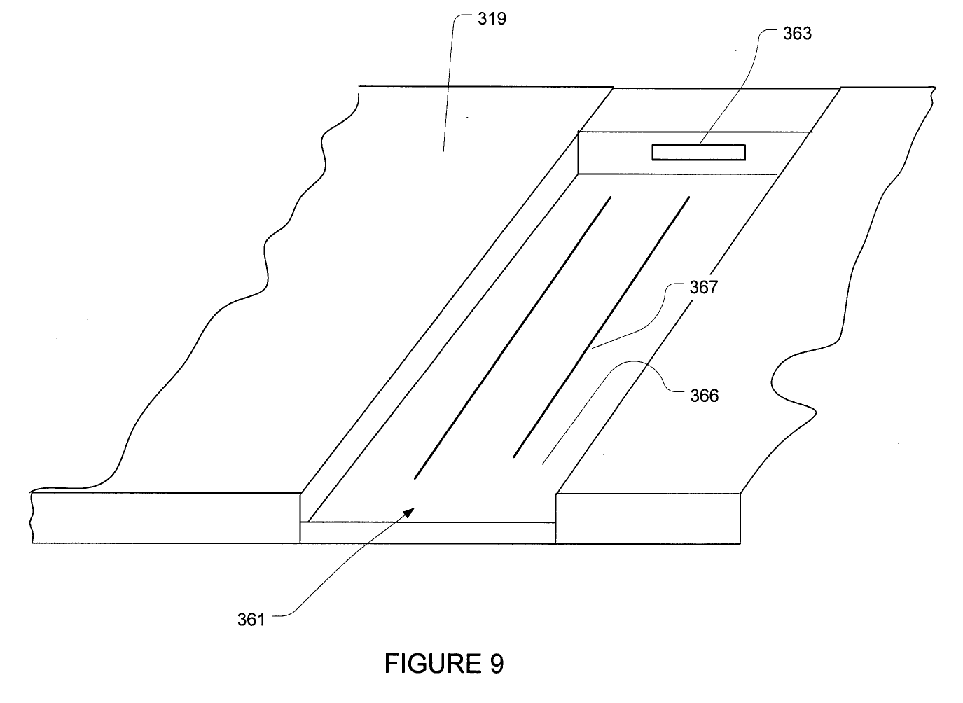

In an aspect of physical removable coupling, with reference to FIG. 4 and 9, base unit 302 may include a receiving portion 361 which is the part of the computer housing 319, such as a case member for a notebook computer. Receiving portion 361 is configured to receive and retain auxiliary computing device 201 therein. Receiving portion 361 can enable connection to the control circuitry 321 shown in FIG. 5 via connector 363. (See FIG. 4). The auxiliary computing device 201 may be mateably disposed to the housing 319 and to control circuitry 321. In one configuration, the synchronization interface 257 (see FIGS. 5 and 6) may be formed as an electrical connector designed to mate with signal interface connection 365. It should be recognized that connector 363 includes electrical connections to the control circuitry 321 as shown in FIG. 6. Interface connection 365 may be within the receiving portion 361 or at a proximate distance from the receiving portion 361. In one example, the connector arrangement may be a USB, mini-USB, USB 2.0 connecting standard. With the USB-OTG standard, the connectors can be provided for the smaller form factor for portable devices. Nevertheless, the synchronization interface 257 and signal interface connection 365 may be of other shapes or designs for the intended use for physical removable coupling and electrically connecting the auxiliary computing system 201 and base unit 302.

In one arrangement, shown in FIG. 9, base unit 302 with housing 319 includes receiving portion 361 formed as a cavities or recesses. In this arrangement, the user may disengage or undock auxiliary computing system 201 from the recess or cavity of receiving portion 361. In another arrangement, auxiliary computing device 201 may be slidably attached or otherwise coupled to the base unit 302. In one arrangement shown in FIG. 9, receiving portion 361 may include a support surface 366, and one or more grooves 367 for slidably guiding the auxiliary computing device 201 (not shown) to mate with a connector 363. Body 238 of computing system 201 may be attached or otherwise removably coupled to housing 319 by way of a snap-fit arrangement. In another arrangement, body 238 may be removable coupled to base unit 302 by way of a spring-catch arrangement. In such an arrangement, a biasing element, such as a spring, may be configured to force a portion of the auxiliary computing system 201 out of the receiving portion 361 in a specific direction in the opening. In one operation with a spring-catch arrangement, when auxiliary computing device 201 is placed in receiving portion 361, a biasing element becomes compressed. The auxiliary computing system 201 may have a ledge or other portion that is catchable so that the body 238 fits and stays within the receiving portion 361 until released. Thus, when a releasing signal is received by control circuitry 321, a latch may release the body 238 so that the biasing member moves the computing system 201 forward in the case of a slidable configuration as shown in FIG. 9 or in the other FIGS. 3, 4 and 7. Likewise, the auxiliary computing system 201 may be released upward and out of the receiving portion 361. The releasing signal may originate from a source, such as base unit 302. Nevertheless, grooves may be place of the device body 238 sidewalls and mating protrusions may be placed on the sidewalls of the receiving portion 361 so that the protrusions slide within the grooves. Alternatively, a protrusions may be provided on the sidewalls of body 238 and grooves on the sidewalls of the receiving portion 361. Accordingly, body 238 can be removably coupled with host computer housing in a number of ways.

In another coupling arrangement, auxiliary computing system 201 electrical power may be drawn from main power, instead of mobile power source 256. Functionally, when physical mating occurs, a connector of auxiliary computing system 201 is sensed by base unit 302. Electrical power from the power source 256 is temporarily disconnected via a switching arrangement. Advantageously, battery power of the computer system 201 is conserved and battery of power source 256 may be recharged. This feature can be implemented in a number of ways. For example, in an USB-OTG configuration, battery power may be drawn from the host device instead of the peripheral device. That is base unit 302 serves as a host device and the computing system 201 serves as a “peripheral device” for charging. It should be recognized that computer system 201 when docked, may be powered by physical mating with charging pins or the like. In one arrangement, when the power source 256 is receiving power, the processing unit 210 via software may report to the base unit 302, that it is receiving external power.

Alternate combinations of various aspects of the computing system arrangements; either alone or in combination with one or more elements have synthetic effects to improve user interaction with a graphic user interface and/or efficiency of operation. For example, in one arrangement, the auxiliary computing system 201 may include a wireless transmitter. When the computing system 201 is physically nested with the base unit 302, there is wired signaling for synchronization of data or other digital services and battery recharging power management.

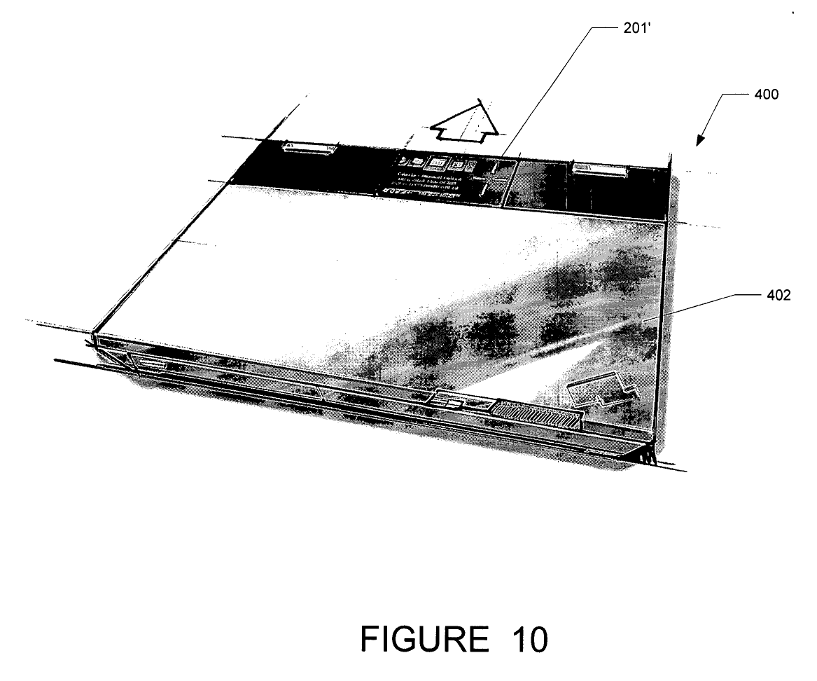

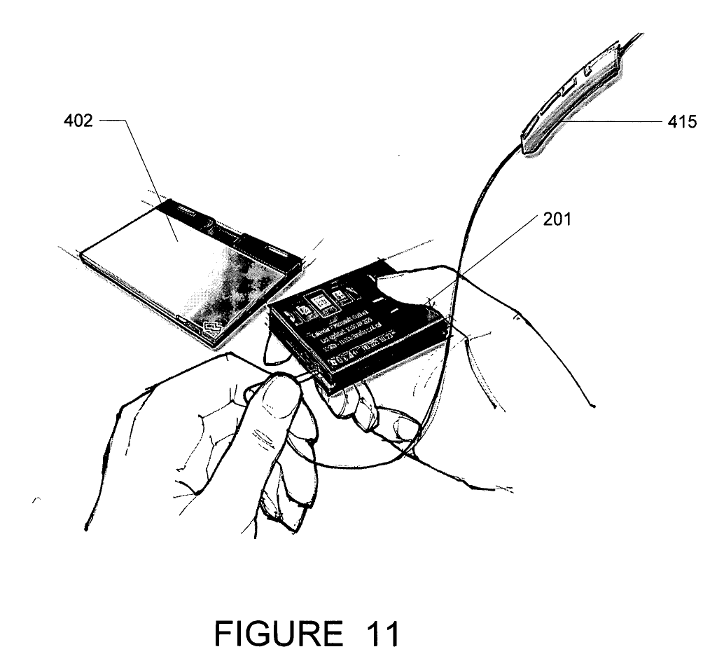

FIGS. 10 and 11 illustrates alternative computing system arrangement 400 which includes a base unit 402 implementing aspects of host computer 100 and an undockable or peel-off portion, such as auxiliary computer system 201. Computer system 201 may be implemented in accordance with various aspects that allow user interaction for manipulating a local graphical user interface for new media technologies and productivity activities, such as creation and modification of electronic documents, spreadsheets, database fields, graphic objects, drawings, photos, calendar, tasks and the like. In one configuration, base unit 402 may be generally embodied in a notebook or laptop configuration. Auxiliary computing system 201 may be embedded within the lid of a laptop in the rear center portion. In FIG. 11, the user has removed the device 201 from the base unit 402 for use in a peel-off mode. The user may connect or otherwise control the auxiliary computing system via remote 415 for volume control and navigation OF A graphical user interface, for example.

There are any number of alternative combinations for defining the invention, which incorporate one or more elements from the specification, including the description, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

1. A computer system, comprising:
a base computing device including a processor configured for operating on computer executable instructions; the base computing device having a housing body with a receiving portion; and
an auxiliary computing device having a housing with a display, the auxiliary computing device including a processor configured to indicate a wireless network location on the display, the auxiliary computing device being removably coupleable to the base computing device in the receiving portion for exposing the display for viewing by a user.

2. The computer system according to claim 1, wherein the wireless network location is displayed as graphical object.

3. The computer system according to claim 2, wherein the graphic object comprises an icon.

4. The computer system according to claim 2, wherein the display includes a graphical system status bar.

5. The computer system according to claim 4, wherein the graphical object is disposed on the graphical system status bar.

6. The computer system according to claim 1, wherein the housing body of the base computing device comprises rotatable mating cases members, wherein one of the cases members includes a display screen on one side and the auxiliary computing device is disposed on an opposing side.

7. The computer system according to claim 6, wherein the one of the case members includes a hinge for rotating the auxiliary computing device with respect to the case member.

8. The computer system according to claim 2, wherein the housing body of the base computing device includes a display screen being sensitive to an input of a stylus and the auxiliary computing device is disposed opposite of the display screen.

9. The computer system according to claim 8, wherein the housing body includes a hinge for rotating the auxiliary computing device into position for a user to view both the display screen of base computing device and the display of the auxiliary computing device.

10. The computer system according to claim 9, wherein the receiving portion of the housing body comprises a recess with a connector receiving the auxiliary computing device.

11. The computer system according to claim 1, wherein the auxiliary computing device is configured to operate when the base computing device is in a powered off state.

12. A computer system comprising:
a base computing device including a processor configured for operating on computer executable instructions; the base computing device having a housing body with a receiving portion;
an auxiliary computing device having a housing with a display, the auxiliary computing device including a processor for operating on computer executable instructions, the auxiliary computing device being removably coupleable to the base computing device in the receiving portion for exposing the display for viewing by a user; and
a remote control device for operating the auxiliary computing device in a peel-off configuration.

13. The computer system according to claim 12, wherein the auxiliary computing device is configured to wirelessly communicate with the base computing device in a peel-off configuration.

14. The computer system according to claim 12, wherein the housing body of the base computing device comprises rotatable mating cases members, wherein one of the cases members includes a display screen on one side and the auxiliary computing device is disposed on an opposing side.

15. The computer system according to claim 14, wherein the one of the case members includes a hinge for rotating the auxiliary computing device with respect to the case member.

16. The computer system according to claim 12, wherein the housing body of the base computing device includes a display screen being sensitive to an input of a stylus and the auxiliary computing device is disposed opposite of the display screen.

17. The computer system according to claim 16, wherein the housing body includes a hinge for rotating the auxiliary computing device into position for a user to view both the display screen of base computing device and the display of the auxiliary computing device.

18. The computer system according to claim 12, wherein the receiving portion of the housing body comprises a recess with a connector receiving the auxiliary computing device.

19. The computer system according to claim 12, wherein the auxiliary computing device is configured to operate when the base computing device is in a powered off state.

20. The computer system according to claim 12, wherein the remote control device is removably connected to the auxiliary computing device.
